(19) United States
(12) Patent Application Publication
(10) Pub. No.: US 2012/0323574 A1
(43) Pub. Date: Dec. 20, 2012

(54) SPEECH TO TEXT MEDICAL FORMS

(75) Inventors: Tao Wang, Beijing (CN); Bin Zhou, Beijing (CN)

(73) Assignee: MICROSOFT CORPORATION, Redmond, WA (US)

(21) Appl. No.: 13/162,586

(22) Filed: Jun. 17, 2011

(51) Int. Cl. G10L 15/08; G10L 17/00

(52) U.S. Cl. 704/246; 704/251; 704/254; 704/E17.001; 704/E15.014

(57) ABSTRACT

Event audio data that is based on verbal utterances associated with a medical event associated with a patient is received. A list of a plurality of candidate text strings that match interpretations of the event audio data is obtained, based on information included in a medical speech repository, information included in a speech accent repository, and a matching function. A selection of at least one of the candidate text strings included in the list is obtained. A population of at least one field of an electronic medical form is initiated, based on the obtained selection.

### BACKGROUND

Medical forms such as physician orders, summaries of events such as patient treatments and patient interviews, and prescription orders have been used by medical personnel globally for many years. For example, an in-patient in a hospital may receive treatment from a physician, and the physician may prescribe a regimen of therapy and medication to be followed on a schedule over time. In order for nurses and hospital technicians to understand the regimen, the physician may write out one or more orders, either on plain paper, or on standard forms provided by the hospital or other medical entity. Alternatively, the physician may physically enter the regimen information into a computer system via a keyboard, or may dictate the regimen into a recording device for later transcription by a medical transcriptionist.

Similarly for out-patient environments, the physician may write recommendations, orders, summaries, and prescriptions on paper, enter them into a computer system via a keyboard, or dictate them for later transcription. Medical support personnel may also be charged with reading paper-based entries to enter the physician's writings into an electronic system.

Insurance providers may provide payment benefits for patients based on predetermined codes established for various types of hospital/medical facility visits, specific tests, diagnoses, treatments, and medications. Pharmacists may fill prescriptions based on what is humanly readable on a prescription form. Similarly, patients and medical support personnel may follow physician orders for the patient based on what is humanly readable on a physician order form, and insurance providers may process requests for benefit payments based on what is readable on a treatment summary form.

### SUMMARY

According to one general aspect, a medical forms speech engine may include a medical speech corpus interface engine configured to access a medical speech repository that includes information associated with a corpus of medical terms. The medical forms speech engine may also include a speech accent interface engine configured to access a speech accent repository that includes information associated with database objects indicating speech accent attributes associated with one or more speakers. The medical forms speech engine may also include an audio data receiving engine configured to receive event audio data that is based on verbal utterances associated with a medical event associated with a patient. The medical forms speech engine may also include a recognition engine configured to obtain a list of a plurality of candidate text strings that match interpretations of the received event audio data, based on information received from the medical speech corpus interface engine, information received from the speech accent interface engine, and a matching function, a selection engine configured to obtain a selection of at least one of the candidate text strings included in the list, and a form population engine configured to initiate, via a forms device processor, population of at least one field of an electronic medical form, based on the obtained selection.

According to another aspect, a computer program product tangibly embodied on a computer-readable medium may include executable code that, when executed, is configured to cause at least one data processing apparatus to receive event audio data that is based on verbal utterances associated with a medical event associated with a patient, and obtain a list of a plurality of candidate text strings that match interpretations of the event audio data, based on information included in a medical speech repository, information included in a speech accent repository, and a matching function. Further, the data processing apparatus may obtain a selection of at least one of the candidate text strings included in the list, and initiate population, via a forms device processor, of at least one field of an electronic medical form, based on the obtained selection.

According to another aspect, a computer program product tangibly embodied on a computer-readable medium may include executable code that, when executed, is configured to cause at least one data processing apparatus to receive an indication of a receipt of event audio data from a user that is based on verbal utterances associated with a medical event associated with a patient, and receive an indication of a list of a plurality of candidate text strings that match interpretations of the event audio data, based on information included in a medical speech repository, information included in a speech accent repository, and a matching function. Further, the data processing apparatus may initiate communication of the list to the user, receive a selection of at least one of the candidate text strings included in the list from the user, and receive template information associated with an electronic medical form. Further, the data processing apparatus may initiate a graphical output depicting a population of at least one field of the electronic medical form, based on the obtained selection and the received template information.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings, and from the claims.

### DRAWINGS

FIG. 1 is a block diagram of an example system for speech to text population of medical forms.

FIGS. 2a-2d are a flowchart illustrating example operations of the system of FIG. 1.

FIG. 3 is a flowchart illustrating example operations of the system of FIG. 1.

FIG. 4 is a block diagram of an example system for speech to text population of medical forms.

FIGS. 5a-5c depict example user views of graphical displays of example medical forms for population.

FIG. 6 depicts an example graphical view of a populated medical report.

### DETAILED DESCRIPTION

In a healthcare environment, patient treatment may be guided by information obtained by medical personnel from medical forms and orders. For example, a medical technician may provide a patient with a glass of water and a specific dosage of a particular prescription medication at a particular time of day based on an entry read by the medical technician from a physician order form associated with the patient. The medical technician may also draw blood specimens in specific amounts, and at specific times, based on another entry on the physician order form. The specimens may be sent for specific testing based on the physician orders.

An out-patient may carefully follow a physician-prescribed regimen based on patient instructions on a physician-provided form. For example, a patient may follow a regimen of bed rest for three days, taking a prescribed antibiotic with food three times each day, until all the antibiotic is consumed, based on a physician-filled form. As another example, a pharmacist may fill a prescription based on information provided by the physician on a prescription form. The pharmacist may understand from the physician instructions that a particular prescription drug, in a particular dosage amount, is prescribed, and that the physician consents to a generic equivalent instead of a brand name medication, if so designated on the form. The pharmacist has a responsibility to understand what may be written on the form, to obtain the correct prescribed medication, and to provide instructions to the medication recipient regarding the prescribed routine for taking or administering the medication.

Physicians and other medical personnel may have limited time to write or enter each individual patient's information on various forms as he/she moves from one patient or medical event to the next scheduled patient or next medical event. For example, an emergency room physician may need to move quickly from one patient medical event to the next, with little to no time available for writing summary information on-the-fly. A surgeon in an operating room may be using both hands for surgical activities, and may need to summarize surgical events in progress, or may need to request supplies such as a bag of a specific blood type or a specific drug that maybe needed immediately to save a patient's life.

As another example, an insurance administrator may decide whether to pay benefits based on information provided by the physician on a diagnosis/treatment summary form. A patient history may also be considered for determining patient eligibility for insurance benefits. As yet another example, information from patient summary forms may be used by other physicians in making decisions regarding various treatments for the patient. For example, a committee making decisions regarding transplant organ recipients may carefully study a history of diagnoses and treatments for particular patients, in researching their decisions.

Example techniques discussed herein may provide physicians and other medical personnel with systems that may accept verbal input to fill entries in medical forms. Thus, a physician treating or otherwise meeting with a patient may speak instructions or summary information, and an example speech-to-text conversion may quickly provide textual information for filling medical forms, as discussed further below. Since many medical terms may have similar sounds in pronunciation (e.g., based on phonemes), or may have closely related, but different, meanings, a matching function may be applied to generate a list of candidate text strings for selection as a result of a speech-to-text conversion.

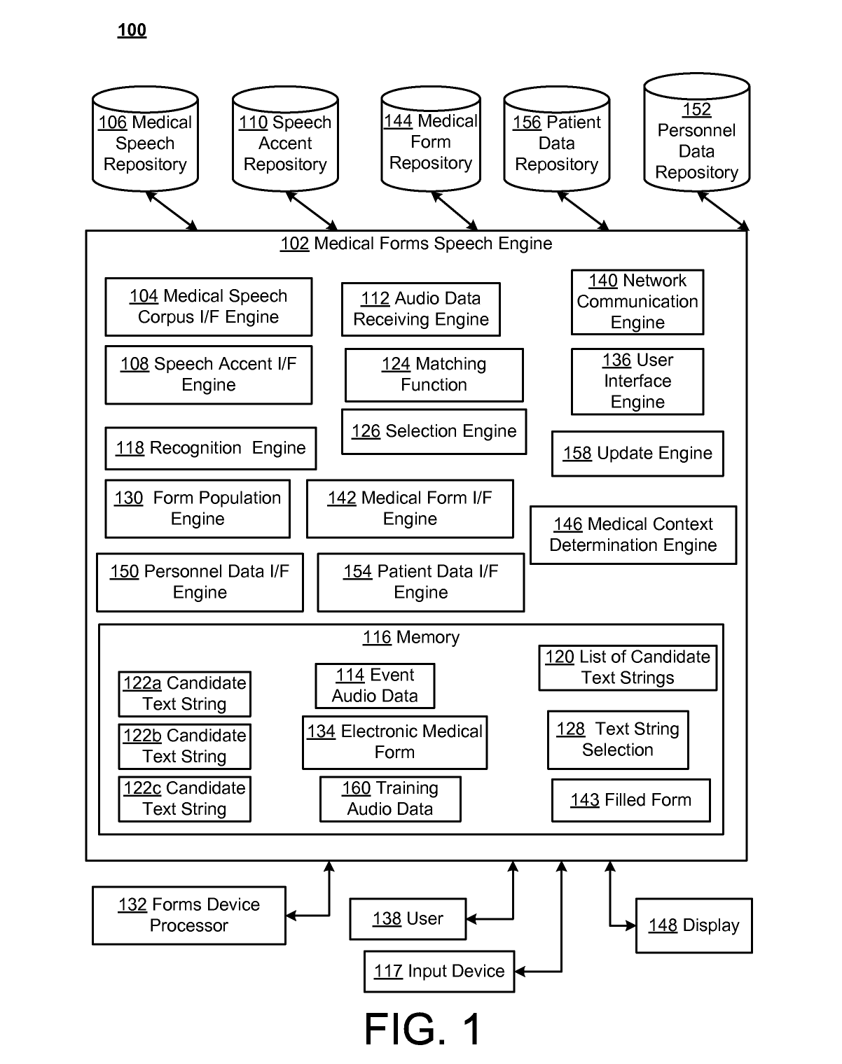

As further discussed herein, FIG. 1 is a block diagram of a system 100 for speech to text population of medical forms. As shown in FIG. 1, a system 100 may include a medical forms speech engine 102 that includes a medical speech corpus interface engine 104 that may be configured to access a medical speech repository 106 that includes information associated with a corpus of medical terms. For example, the medical speech repository 106 may include text strings associated with standard medical terms, as well as text strings that may be used in a localized environment such as a medical care center or chain (e.g., a hospital or private office of a physician). The medical speech repository 106 may also include information associating various audio data with the medical terms, including information regarding terms that may have similar pronunciations, as well as terms that may have different pronunciations, but similar meanings. For example, in a particular context, a particular term may be meaningful, but another term that has a different pronunciation may provide a meaning with better clarity for a given situation, in a medical environment.

According to an example embodiment, the medical speech repository 106 may include text strings associated with medical terms that include names of diseases (e.g., cold, chicken pox, measles), names of drugs (e.g., aspirin, penicillin), names associated with dosages (e.g., 25 mg, 3× daily, take 2 hours before or after meals), names associated with medical diagnoses (e.g., myocardial infarction, stress fracture), names of body parts (e.g., tibia, clavicle), names of patient complaints (e.g., fever, temperature measurements, nausea, dizziness), names of observations (e.g., contusion, confusion, obese, alert), names of tests and results (e.g., blood pressure, pulse, weight, temperature, cholesterol numbers, blood sample), and names associated with patient histories (e.g., family history of cancer, non-smoker, social drinker, three pregnancies).

A speech accent interface engine 108 may be configured to access a speech accent repository 110 that includes information associated with database objects indicating speech accent attributes associated with one or more speakers. For example, a speaker may speak with a dialect associated with a distinct region or province of a country (e.g., with a “Boston accent” or a “Texas drawl”). Further, each individual speaker may have personal speech attributes associated with their individual speech patterns, which may be discernable via voice recognition techniques. For example, a user of the system 100 may provide a training sample of his/her voice speaking various predetermined terms so that audio attributes of that user's speech may be stored in the speech accent repository 110 for use in matching audio data with terms in the medical speech repository 106 (e.g., via speech recognition). According to an example embodiment, the information stored in the speech accent repository 110 may also be used to determine an identification of a user (e.g., via voice recognition). According to an example embodiment, the information stored in the speech accent repository 110 may include speech accent information that is not personalized to particular users.

An audio data receiving engine 112 may be configured to receive event audio data 114 that is based on verbal utterances associated with a medical event associated with a patient. According to an example embodiment, a memory 116 may be configured to store the audio data 114. In this context, a “memory” may include a single memory device or multiple memory devices configured to store data and/or instructions. Further, the memory 116 may span multiple distributed storage devices.

For example, a physician or other medical personnel may speak in range of an input device 117 that may include an audio input device, regarding the medical event. According to an example embodiment, the medical event may include a medical treatment event associated with the patient, a medical review event associated with the patient, a medical billing event associated with the patient, a medical prescription event associated with the patient, or a medical examination event associated with the patient. Thus, for example, a physician may be examining an in-patient in a hospital room, and may be speaking observations and instructions while he/she is with the patient. Thus, it may be possible to provide a verbal input to the input device 117 at the same time as providing verbal information to the patient or to caregivers of the patient.

For example, the input device 117 may include a mobile audio input device that may be carried with the physician as he/she navigates from one patient event to the next. For example, the event audio data 114 may be transmitted via a wired or wireless connection to the medical forms speech engine 102. The input device 117 may also include one or more audio input devices (e.g., microphones) that may be located in the patient rooms or in the hallways outside the patient rooms, or in offices provided for medical personnel.

A recognition engine 118 may be configured to obtain a list 120 of a plurality of candidate text strings 122a, 122b, 122c that match interpretations of the received event audio data 114, based on information received from the medical speech corpus interface engine 104, information received from the speech accent interface engine 108, and a matching function 124. For example, the matching function 124 may include a fuzzy matching technique which may provide suggestions of text strings that approximately match portions of the event audio data 114, based on information included in the medical speech repository 106 and the speech accent repository 110, as discussed further below.

It may be understood that while three candidate text strings 122a, 122b, 122c are depicted in FIG. 1, there may exist two, three, or any number of such candidate text strings in the list 120.

For example, a speech recognition technique may include extracting phonemes from the event audio data 114. For example, phonemes may be formally described as linguistic units, or as sounds that may be aggregated by humans in forming spoken words. For example, a human conversion of a phoneme into sound in speech may be based on factors such as surrounding phonemes, an accent of the speaker, and an age of the speaker. For example, a phoneme of “uh” may be associated with the “oo” pronunciation for the word “book” while a phoneme of “uw” may be associated with the “oo” pronunciation for the word “too.”

For example, the phonemes may be extracted from the event audio data 114 via an example extraction technique based on at least one Fourier transform (e.g., if the event audio data 114 is stored in the memory 116 based on at least one representation of waveform data). For example, a Fourier transform may include an example mathematical operation that may be used to decompose a signal (e.g., an audio signal generated via an audio input device) into its constituent frequencies.

For example, the extracted phonemes may be arranged in sequence (e.g., the sequence as spoken by the speaker of the event audio data 114), and a statistical analysis may be performed based on at least one Markov model, which may include at least one sequential path of phonemes associated with spoken words, phrases, or sentences associated with a particular natural language.

One skilled in the art of data processing may appreciate that there are many techniques available for translating voice to text and for speech recognition, and that variations of these techniques may also be used, without departing from the spirit of the discussion herein.

A selection engine 126 may be configured to obtain a selection 128 of at least one of the candidate text strings 122a, 122b, 122c included in the list 120. For example, the list 120 may be presented to a user for selection by the user. For example, the list 120 may be presented to the user in text format on a display or in audio format (e.g., read to the user as a text-to-speech operation). The user may then provide the selection 128 of a text string. According to an example embodiment, the user may select one of the candidate text strings 122a, 122b, 122c included in the list 128, and may then further edit the text string into a more desirable configuration for entry into a form.

A form population engine 130 may be configured to initiate, via a forms device processor 132, population of at least one field of an electronic medical form 134, based on the obtained selection 128. For example, the form population engine 130 may populate a “diagnosis” field of the electronic medical form 134 with the obtained selection 128, which may include a selection by a physician of an appropriate text string derived from the event audio data 114. In this context, a “processor” may include a single processor or multiple processors configured to process instructions associated with a processing system. A processor may thus include multiple processors processing instructions in parallel and/or in a distributed manner.

According to an example embodiment, the matching function 124 may include a matching function configured to determine a first candidate text string and at least one fuzzy derivative candidate text string, a matching function configured to determine the plurality of candidate text strings based on at least one phoneme, a matching function configured to determine the plurality of candidate text strings based on a history of selected text strings associated with a user, or a matching function configured to determine the plurality of candidate text strings based on a history of selected text strings associated with the patient.

For example, the matching function 124 may include a fuzzy matching algorithm configured to determine a plurality of candidate text strings 122a, 122b, 122c that are approximate textual matches as transcriptions of portions of the event audio data 114. For example, the fuzzy matching algorithm may determine that a group of text strings are all within a predetermined threshold value of “closeness” to an exact match based on comparisons against the information in the medical speech repository 106 and the speech accent repository 110. The candidate text strings 122a, 122b, 122c may then be “proposed” to the user, who may then accept a proposal or edit a proposal to more fully equate with the intent of the user in his/her speech input. In this way, fuzzy matching may expedite the transcription process and provide increased productivity for the user.

According to an example embodiment, a user interface engine 136 may be configured to manage communications between a user 138 and the medical forms speech engine 102. A network communication engine 140 may be configured to manage network communication between the medical forms speech engine 102 and other entities that may communicate with the medical forms speech engine 102 via one or more networks.

According to an example embodiment, a medical form interface engine 142 may be configured to access a medical form repository 144 that includes template information associated with a plurality of medical forms stored in an electronic format. For example, the medical form interface engine 142 may access the medical form repository 144 by requesting template information associated with a patient event summary form. For example, the patient event summary form may include fields for a name of the patient, a name of an attending physician, a date of the patient event, a patient identifier, a summary of patient complaints and observable medical attributes, a patient history, a diagnosis summary, and a summary of patient instructions. For example, the template information may be provided in a structured format such as HyperText Markup Language (HTML) or Extensible Markup Language (XML) format, and may provide labels for each field for display to the user. For example, the template information may be stored in a local machine or a server such as a Structured Query Language (SQL) server. For example, the medical form interface engine 142 may access the medical form repository 144 locally, or via a network such as the Internet.

For example, the medical form repository 144 may include information associated with predetermined codes established for various types of hospital/medical facility visits, specific tests, diagnoses, treatments, and medications, for inclusion with example forms for submission to insurance providers for payment of benefits.

According to an example embodiment, the form population engine 130 may be configured to initiate population of at least one field of the electronic medical form 134, based on the obtained selection 128, and based on template information received from the medical form interface engine 142. According to an example embodiment, the memory 116 may be configured to store a filled form 143 that includes text data that has been filled in for a particular electronic medical form 134. According to an example embodiment, structure and formatting data (e.g., obtained from the template information stored in the medical form repository 144) may also be stored in the filled form 143 data. According to an example embodiment, the filled form 143 may include indicators associated with a form that is stored in the medical form repository 144, to provide retrieval information for retrieving the template information associated with the filled form 143 for viewing, updating or printing the filled form 143.

For example, the user 138 may select the selection 128 in response to a prompt to select a candidate text string 122a, 122b, 122c from the list 120, and the form population engine 130 may update the filled form 143 to include the selected text string 128 in association with a field included in the electronic medical form 134 that the user 138 has requested for entry of patient information.

According to an example embodiment, a medical context determination engine 146 may be configured to determine a medical context based on the received event audio data 114, wherein the medical form interface engine 146 may be configured to request template information associated with at least one medical form associated with the determined medical context from the medical form repository 144. For example, the user 138 may speak words that are frequently used in a context of prescribing a prescription medication (e.g., a name and dosage of a prescription medication), and the medical context determination engine 146 may determine that the context is a prescription context. A request may then be sent for the medical form interface engine 146 to request template information associated with a prescription form from the medical form repository 144, which may then be stored in the electronic medical form 134. According to an example embodiment, the form may then be displayed on a display device 148 for viewing by the user 138 as he/she requests population of various fields of the electronic medical form 134.

As another example, portions of the form may be read (e.g., via text-to-speech techniques) to the user 138 so that the user 138 may verbally specify fields and information for populating the fields. As another example, the user 138 may dictate information for populating the fields of the form based on the user's knowledge and experience with the form, and the medical context determination engine 146 may determine which fields are associated with the portions of the event audio data 114 that pertain to the particular fields (e.g., name of patient, name of prescription drug, name of diagnosis). The medical context determination engine 146 may then provide the determined context to the form population engine 130 for population of the fields associated with the contexts. The medical context determination engine 146 may also provide the determined context to the recognition engine 118 as additional information for use in obtaining the list 120.

According to an example embodiment, the user interface engine 136 may be configured to receive a confirmation of a completion of population of the electronic medical form 134 from a user of the electronic medical form 134. For example, the user 138 may indicate a request for a display of the filled form 143 for verification and signature.

According to an example embodiment, the user interface engine 136 may be configured to obtain an identification of the user of the electronic medical form 134. For example, the user 138 may speak identifying information such as his/her name, employee identification number, or other identifying information. For example, the user 138 may swipe or scan an identification card via a swiping or scanning input device included in the input device 117. For example, the user 138 may provide a fingerprint for identification via a fingerprint input device included in the input device 117.

According to an example embodiment, a personnel data interface engine 150 may be configured to access a personnel data repository 152 that may be configured to store information associated with personnel associated with the medical facility associated with the system 100. For example, the personnel data repository 152 may store identifying information associated with physicians, nurses, administrative personnel, and medical technicians. For example, the identifying information may include a name, an employee number or identifier, voice recognition information, fingerprint recognition information, and authorization levels. For example, a physician may be authorized to provide and update patient prescription information associated with narcotic drugs, while administrative personnel may be blocked from entry of prescription information. Thus, for example, non-physician administrative personnel may not be allowed to access a prescription form from the medical form repository 144.

According to an example embodiment, a patient data interface engine 154 may be configured to access a patient data repository 156 that may be configured to store information associated with patients who are associated with the medical facility that manages the system 100. For example, the patient data repository 156 may include electronic medical record information related to patients. For example, the patient data repository 156 may include medical histories and patient identifying information similar to the identifying information discussed above with regard the medical personnel identifying information.

According to an example embodiment, medical personnel or a patient may be identified based on input information and information obtained from the personnel data repository 152 or the patient data repository 156, and corresponding fields of the electronic medical form 134 may be populated based on the identifying information. For example, if a user 138 is identified by voice recognition, then the name of the user 138 may be filled in for a physician name in the electronic medical form 134, thus saving the user 138 the time of specifying his/her name with regard to that particular field.

According to an example embodiment, information included in the personnel data repository 152 and/or the patient data repository 156 may be updated based on information entered into the filled form 143 by the medical forms speech engine 102. According to an example embodiment, the personnel data repository 152 and/or the patient data repository 156 may be included in an electronic medical records system associated with a medical facility.

According to an example embodiment, the recognition engine 118 may be configured to obtain the list 120 based on information included in the medical speech repository 106, information that is associated with the user and is included in the speech accent repository 110, and the matching function 124. For example, the user 138 may develop a history of selecting particular text strings based on particular speech input, and the speech accent repository 110 may be updated to reflect the particular user's historical selections. Thus, the speech accent repository 110 may be trained over time to provide better matches for future requests from individual users 1138.

According to an example embodiment, the user interface engine 136 may be configured to obtain an identification of the user of the electronic medical form 134, based on receiving an indication of the identification from the user 138 or obtaining the identification based on matching a portion of the event audio data 114 with a portion of the information included in the speech accent repository 110, based on voice recognition.

According to an example embodiment, the verbal utterances may be associated with a physician designated as a physician responsible for treatment of the patient.

According to an example embodiment, the user interface engine 136 may be configured to obtain an identification of the electronic medical form 134 from the user 138, and initiate transmission of template information associated with the electronic medical form 134 to the display device 148 associated with the user 138, based on the identification of the electronic medical form 134. For example, the user 138 may manually or verbally request a prescription form, and the user interface engine 136 may receive the input, and initiate transmission of template information associated with the prescription form to the display device 148 for rendering a graphical display of the form for the user 138.

According to an example embodiment, the recognition engine 118 may be configured to obtain an identification of the electronic medical form 134, based on the received event audio data 114, and the user interface engine 136 may be configured to initiate access to the electronic medical form 134, based on the identification of the electronic medical form 134.

According to an example embodiment, the recognition engine 118 may be configured to obtain the identification of the electronic medical form 134, based on the received event audio data 114, based on an association of the electronic medical form 134 with at least one interpretation of at least one portion of the received event audio data 114. For example, the medical context determination engine 146 may determine a prescription context based on the event audio data 114, and may indicate an identification of a prescription context to the recognition engine 118, so that the recognition engine 118 may obtain an identification of a prescription form.

According to an example embodiment, the recognition engine 118 may be configured to obtain the list 120 based on obtaining the list of the plurality of candidate text strings 122a, 122b, 122c that match interpretations of the event audio data 114, based on information included in the medical speech repository 106 that includes information associated with a vocabulary that is associated with medical professional terminology and a vocabulary that is associated with a predetermined medical environment. For example, the medical speech repository 106 may include information associated with medical professionals worldwide, as well as localized information associated with medical personnel locally (e.g., within the environment of the medical facility). For example, personnel local to a particular medical facility may use names and descriptions that develop over time in a local community, and that may not be globally recognized.

According to an example embodiment, the user interface engine 136 may be configured to receive at least one revision to the selected text string 128, based on input from the user 138. For example, the user 138 may be provided the list 120, and may decide to revise at least one of the candidate text strings 122a, 122b, 122c for better clarity of the text for entry in the filled form 143.

According to an example embodiment, an update engine 158 may be configured to receive training audio data 160 that is based on verbal training utterances associated with the user 138 of the electronic medical form 134, and initiate an update event associated with the speech accent repository 110 based on the received training audio data 160. For example, the user 138 may provide training audio input that may include audio data of the user 138 reading predetermined summary data and prescription data, for training the speech accent repository 110 to better match event audio data 114 obtained from the user 138 with information included in the medical speech repository 106.

According to an example embodiment, the update engine 158 may be configured to initiate an update event associated with the speech accent repository 110 based on the obtained selection 128. For example, the speech accent repository 110 may receive training information associated with the user 138 over time, based on a history of text string selections 128 that are based on the received event audio data 114.

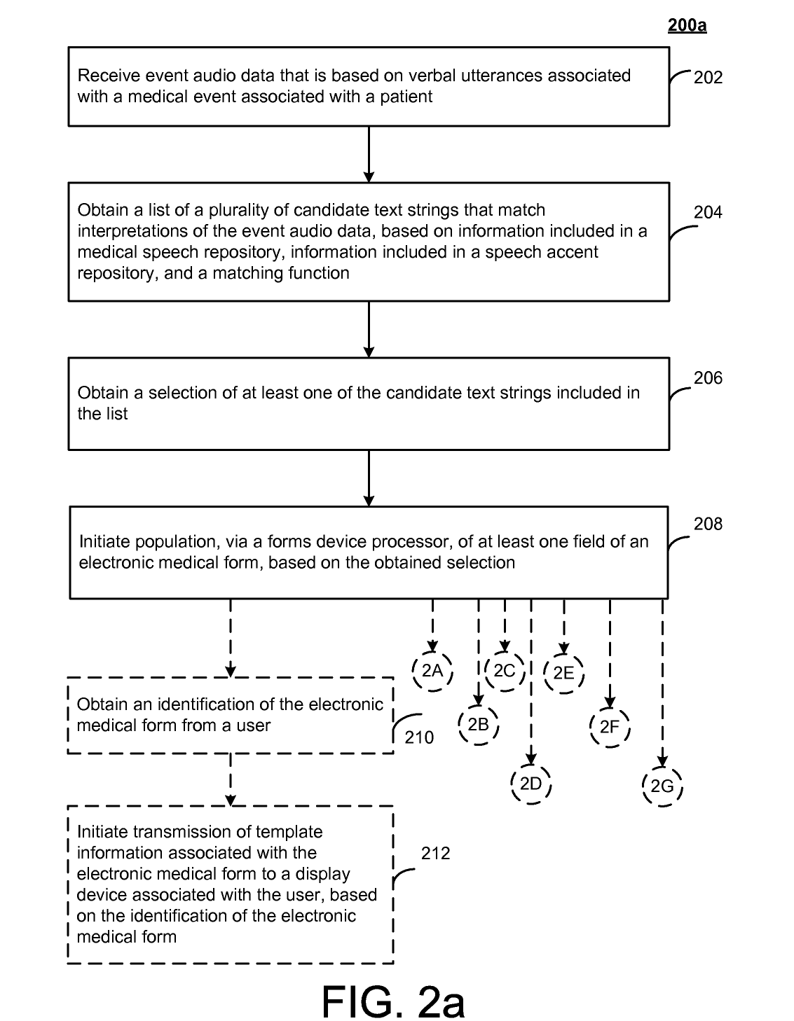

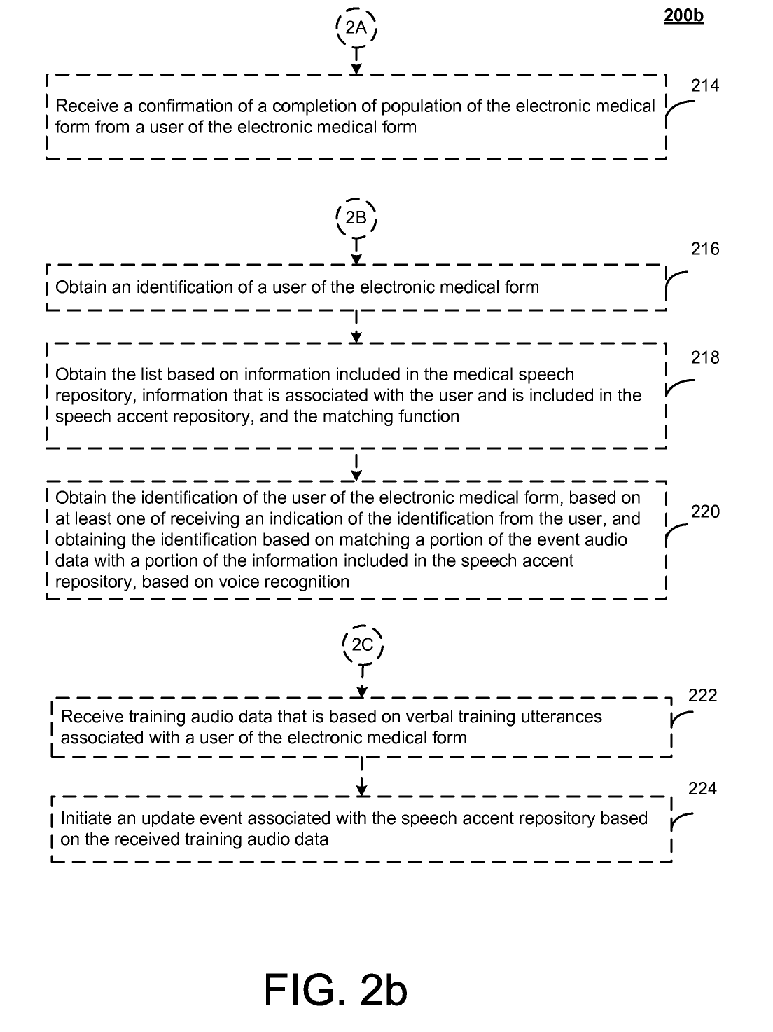

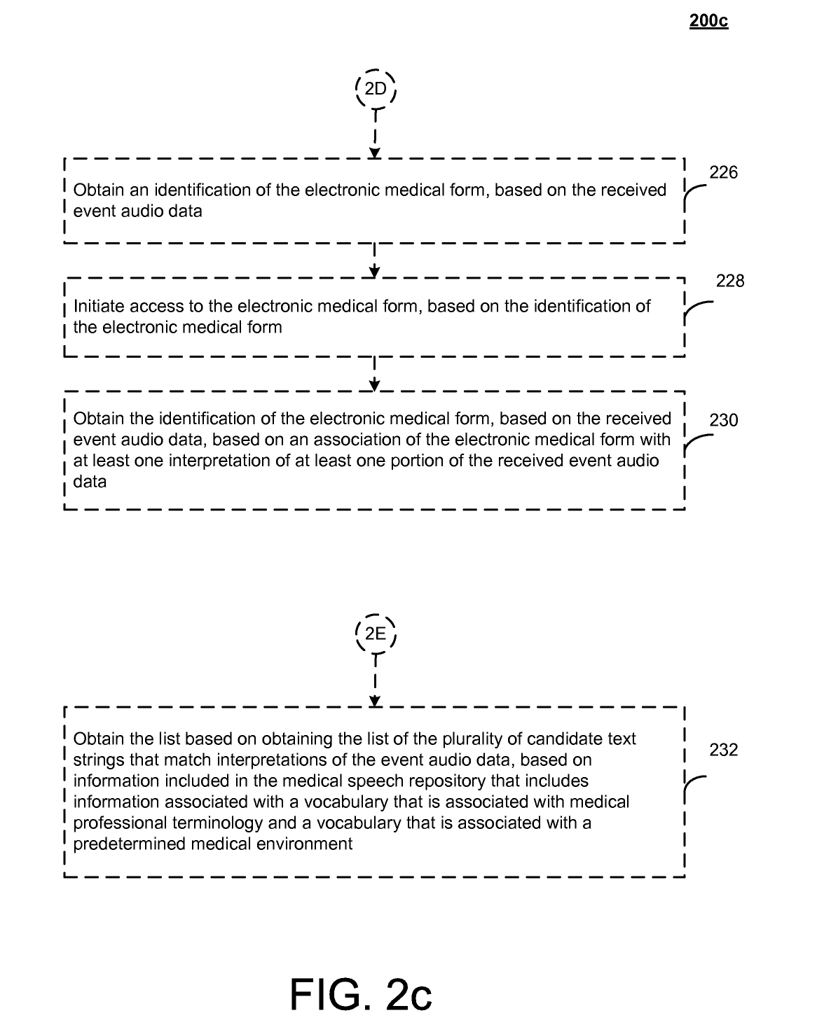

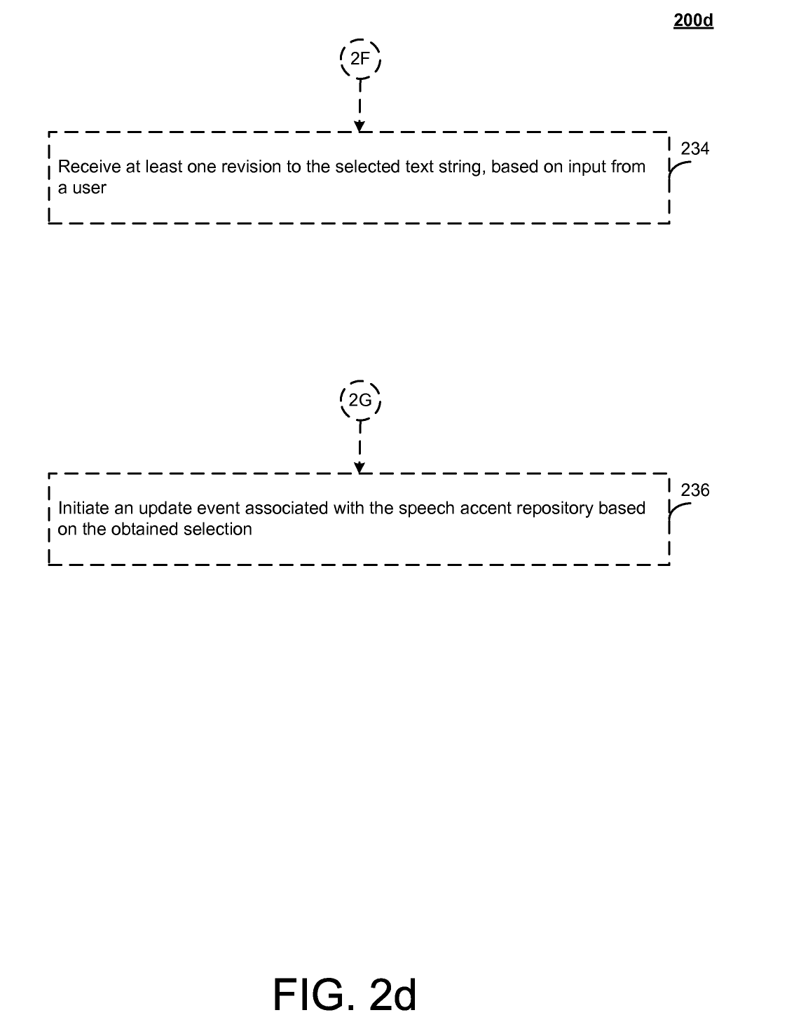

FIGS. 2a-2d are a flowchart 200 illustrating example operations of the system of FIG. 1, according to example embodiments. In the example of FIG. 2, event audio data that is based on verbal utterances associated with a medical event associated with a patient may be received (202). For example, the audio data receiving engine 112 may receive event audio data 114 that is based on verbal utterances associated with a medical event associated with a patient, as discussed above.

A list of a plurality of candidate text strings that match interpretations of the event audio data may be obtained, based on information included in a medical speech repository, information included in a speech accent repository, and a matching function (204). For example, the recognition engine 118 as discussed above may obtain a list 120 of a plurality of candidate text strings 122a, 122b, 122c that match interpretations of the received event audio data 114, based on information received from the medical speech corpus interface engine 104, information received from the speech accent interface engine 108, and a matching function 124.

A selection of at least one of the candidate text strings included in the list may be obtained (206). For example, the selection engine 126 may obtain a selection 128 of at least one of the candidate text strings 122a, 122b, 122c included in the list 120, as discussed above.

A population of at least one field of an electronic medical form may be initiated, via a forms device processor, based on the obtained selection (208). For example, the form population engine 130 may initiate, via the forms device processor 132, population of at least one field of the electronic medical form 134, based on the obtained selection 128, as discussed above.

According to an example embodiment, an identification of the electronic medical form may be obtained from a user (210). According to an example embodiment, transmission of template information associated with the electronic medical form to a display device associated with the user may be initiated, based on the identification of the electronic medical form (212). For example, the user interface engine 136 may receive the identification of the electronic medical form 134 from the user 138, and may initiate transmission of template information associated with the electronic medical form 134 to the display device 148.

According to an example embodiment, a confirmation of a completion of population of the electronic medical form may be received from a user of the electronic medical form (214), as discussed above.

According to an example embodiment, an identification of a user of the electronic medical form may be obtained (216). According to an example embodiment, the list may be obtained based on information included in the medical speech repository, information that is associated with the user and is included in the speech accent repository, and the matching function (218). For example, the recognition engine 118 may obtain the list 120, as discussed above.

According to an example embodiment, the identification of the user of the electronic medical form may be obtained based on at least one of receiving an indication of the identification from the user, and obtaining the identification based on matching a portion of the event audio data with a portion of the information included in the speech accent repository, based on voice recognition (220), as discussed above.

According to an example embodiment, training audio data may be received that is based on verbal training utterances associated with a user of the electronic medical form (222). An update event associated with the speech accent repository may be initiated based on the received training audio data (224). For example, the update engine 158 may receive the training audio data 160 and initiate an update event associated with the speech accent repository 110 based on the received training audio data 160, as discussed above.

According to an example embodiment, an identification of the electronic medical form may be obtained, based on the received event audio data (226). Access to the electronic medical form may be initiated, based on the identification of the electronic medical form (228). According to an example embodiment, the identification of the electronic medical form may be obtained based on the received event audio data, based on an association of the electronic medical form with at least one interpretation of at least one portion of the received event audio data (230). For example, the recognition engine 118 may obtain the identification of the electronic medical form 134, based on the received event audio data 114, based on an association of the electronic medical form 134 with at least one interpretation of at least one portion of the received event audio data 114, as discussed above.

According to an example embodiment, the list may be obtained based on obtaining the list of the plurality of candidate text strings that match interpretations of the event audio data, based on information included in the medical speech repository that includes information associated with a vocabulary that is associated with medical professional terminology and a vocabulary that is associated with a predetermined medical environment (232). For example, the recognition engine 118 may obtain the list 120, as discussed above.

According to an example embodiment, at least one revision to the selected text string may be received, based on input from a user (234). For example, the user interface engine 136 may receive at least one revision to the selected text string 128, based on input from the user 138, as discussed above.

According to an example embodiment, an update event associated with the speech accent repository may be initiated based on the obtained selection (236). For example, the update engine 158 may initiate an update event associated with the speech accent repository 110 based on the obtained selection 128, as discussed above.

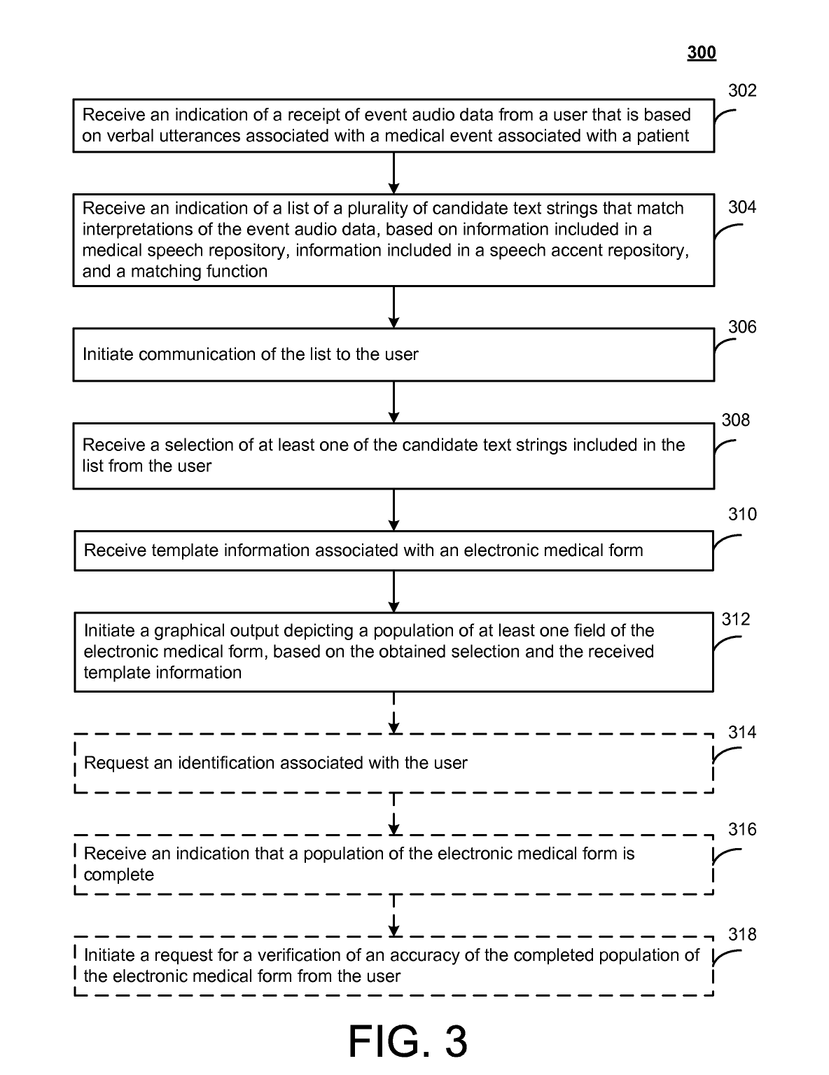

FIG. 3 is a flowchart illustrating example operations of the system of FIG. 1, according to example embodiments. In the example of FIG. 3, an indication of a receipt of event audio data may be received from a user that is based on verbal utterances associated with a medical event associated with a patient (302). For example, the user interface engine 136 may receive the indication of the receipt of the event audio data 114 from the user 138. According to an example embodiment, a user interface engine may also be located on a user device that may be located external to the medical forms speech engine 102, and that may include at least a portion of the input device 117 and/or the display 148. For example, the user 138 may use a computing device such as a portable communication device or a desktop device that may include at least a portion of the input device 117 and/or the display 148, and that may be in wireless or wired communication with the medical forms speech engine 102, and that may include the user interface engine for the user device.

An indication of a list of a plurality of candidate text strings that match interpretations of the event audio data may be received, based on information included in a medical speech repository, information included in a speech accent repository, and a matching function (304). For example, the user interface engine discussed above with regard to the user 138 computing device may receive an indication of the list 120.

Communication of the list to the user may be initiated (306). For example, the user interface engine discussed above with regard to the user 138 computing device may initiate a communication of the list 120 to the user 138. For example, the communication may be initiated as a displayed graphical communication or as an audio communication of the list 120 to the user 138.

A selection of at least one of the candidate text strings included in the list may be received from the user (308). For example, the user interface engine discussed above with regard to the user 138 computing device may receive the selection 128 and may forward the selection 128 to the user interface engine 136 that is included in the medical forms speech engine 102.

Template information associated with an electronic medical form may be received (310). A graphical output depicting a population of at least one field of the electronic medical form may be initiated, based on the obtained selection and the received template information (312). For example, the user interface engine discussed above with regard to the user 138 computing device may receive template information such as the template information included in the medical form repository 144 that may be associated with the filled form 143, and may initiate the graphical output for the user 138.

According to an example embodiment, an identification associated with the user may be requested (314).

According to an example embodiment, an indication that a population of the electronic medical form is complete may be received (316). According to an example embodiment, a request may be initiated for a verification of an accuracy of the completed population of the electronic medical form from the user (318). For example, the user interface engine discussed above with regard to the user 138 computing device may receive the indication the population is complete from the user 138. For example, the user interface engine discussed above with regard to the user 138 computing device may initiate a request for verification of the accuracy of the completed population from the user 138.

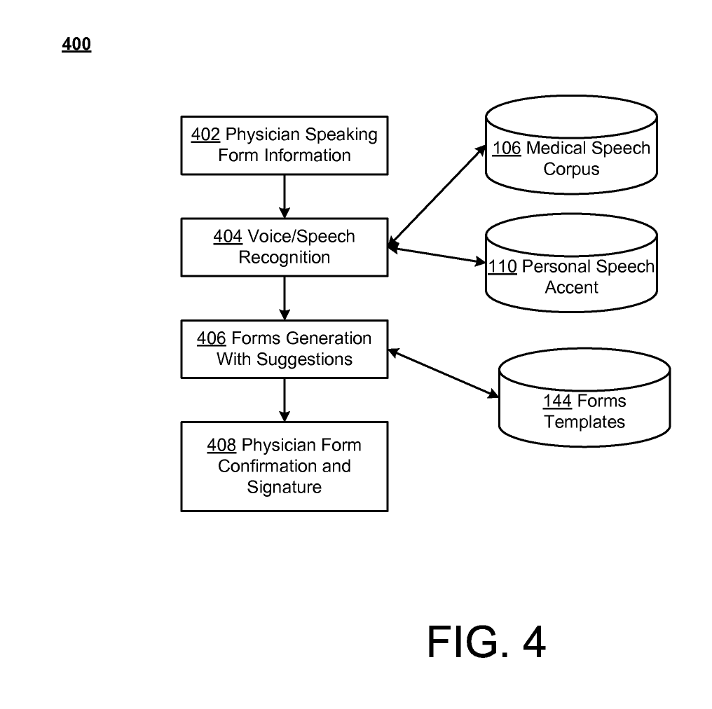

FIG. 4 is a block diagram of an example system for speech to text population of medical forms. As shown in FIG. 4, a physician may speak form information (402). For example, the user 138 may include a physician speaking information associated with the electronic medical form 134 into the input device 117, as discussed above. Voice/speech recognition may be performed on the spoken form information (404). For example, the recognition engine 118 may perform the voice/speech recognition based at least on information included in the medical speech repository 106 and the speech accent repository 110, as discussed above.

Forms may be generated with suggestions (406). For example, the recognition engine 118 may be configured to obtain the list of candidate strings 120, as discussed above. For example, the form population engine 130 may initiate, via the forms device processor 132, population of at least one field of the electronic medical form 134, based on the obtained selection 128, as discussed above. For example, the memory 116 may store the filled form 143 that includes text data that has been filled in for a particular electronic medical form 134. For example, structure and formatting data (e.g., obtained from the template information stored in the medical form repository 144) may also be stored in the filled form 143 data, as discussed above.

For example, the user interface engine 136 may receive a confirmation of a completion of population of the electronic medical form 134 from a user of the electronic medical form 134. For example, the user 138 may indicate a request for a display of the filled form 143 for verification and signature, as discussed above.

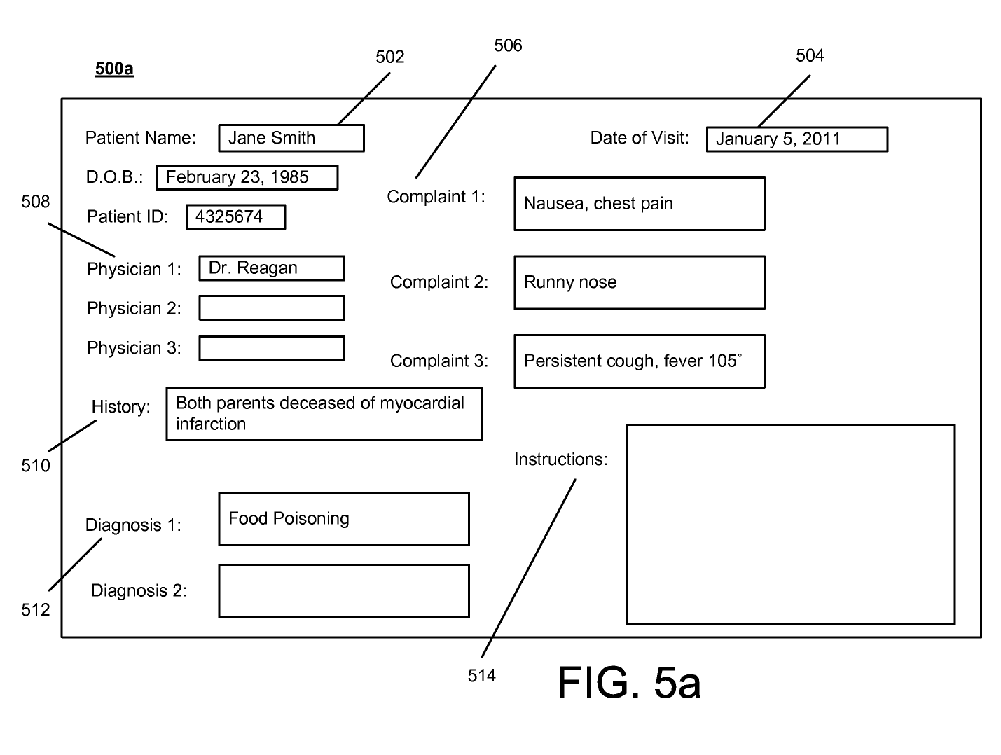

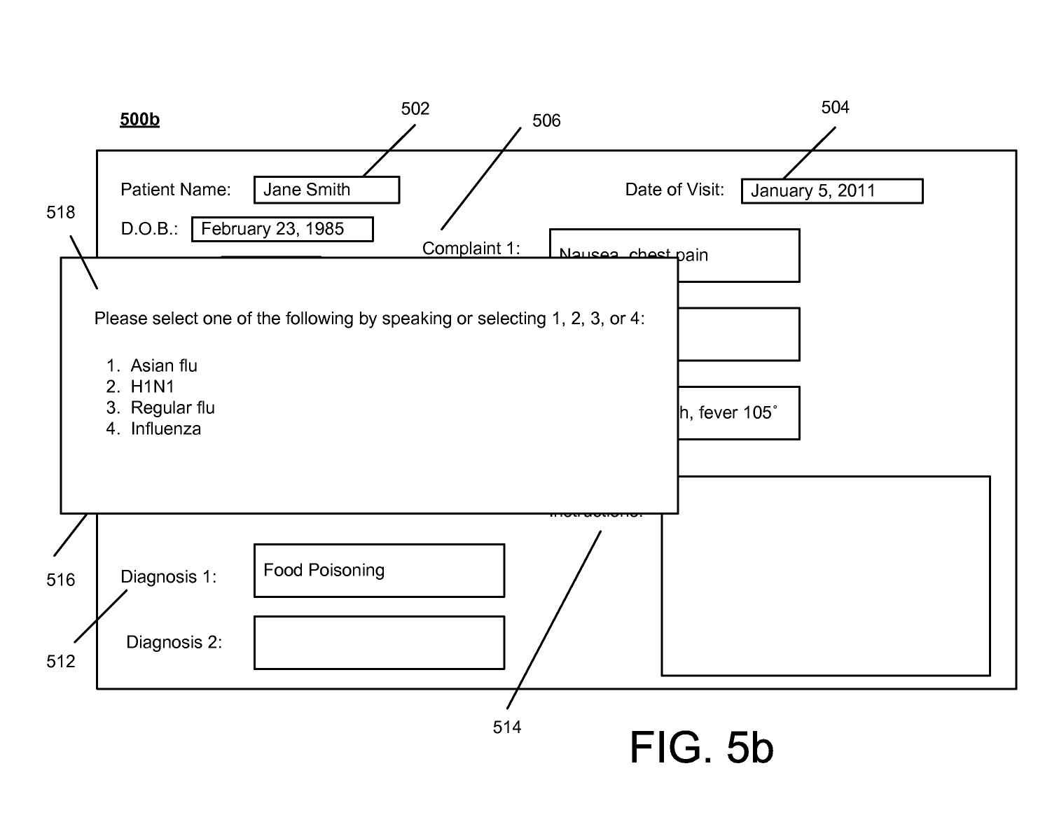

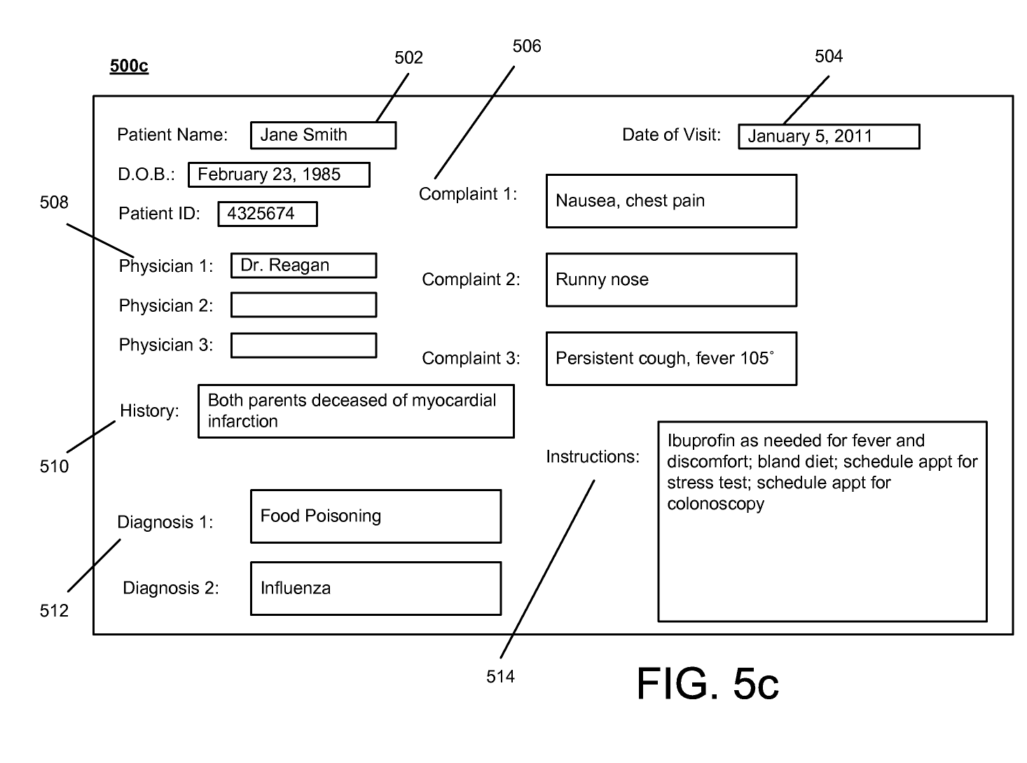

FIGS. 5a-5c depict example user views of graphical displays of example medical forms for population. As shown in FIG. 5a, an example patient event summary form 500a may be displayed. For example, the user interface engine 136 may provide template information from the electronic medical form 134 or the filled form 143 to the display device 148 for rendering a graphical display 500a of the form for the user 138.

As shown in FIG. 5a, an example patient name field may include a text box 502 for receiving information regarding the patient name. For example, the patient name may be provided by the user 138 verbally, for speech to text processing by the recognition engine 118 as discussed above. Alternatively, the patient name may be typed in by the user 138 via the input device 117, or the patient name may be retrieved from the patient data repository 156, as discussed above.

A date field may include a text box 504 for receiving information regarding the date of a patient visit. For example, the date may be automatically filled in by the system 100 or may be provided verbally or manually by the user 138.

A complaint field may include a text box 506 for receiving information regarding at least one complaint of the patient. For example, the complaint information may be provided verbally or manually by the user 138. For example, the complaint information may be retrieved from the patient data repository 156 (e.g., if the patient has an ongoing complaint such as symptoms related to cancer or cancer treatments). A physician field may include a text box 508 for receiving information regarding a name of a physician. For example, the physician name information may be provided verbally or manually by the user 138. For example, the physician name information may be retrieved from the personnel data repository 152 (e.g., if the physician has been authenticated prior to receiving the display 500a).

A history field may include a text box 510 for receiving information regarding medical and/or social history of the patient. For example, the history information may be provided verbally or manually by the user 138. For example, the history information may be retrieved from the patient data repository 156 (e.g., if the patient has an ongoing complaint). A diagnosis field may include a text box 512 for receiving information regarding at least one diagnosis of the patient. For example, the diagnosis information may be provided verbally or manually by the user 138.

An instructions field may include a text box 514 for receiving information regarding instructions regarding the patient. For example, the instructions information may be provided verbally or manually by the user 138.

FIG. 5b depicts the display of the example patient event summary form of FIG. 5a, with an example window 518 displaying a request for a selection from a list of suggested diagnoses for populating the diagnosis text box 512. For example, the user 138 may have spoken the word “flu” for populating the diagnosis text field 512, and the recognition engine 118 may have obtained the list of candidate text strings 128, as discussed above. For the example of FIG. 5b, the list 128 includes “Asian flu,” “H1N1,” “Regular flu,” and “Influenza.” As discussed above, the list may be graphically displayed to the user on the display 148, or may be displayed as audio output to the user 138 via the display device 148 (e.g., via a speaker device). As discussed above, the user 138 may select one of the list items verbally or manually, or may revise one of the suggested items.

FIG. 5c depicts a populated form 500c after population of the fields by the form population engine 130. The user 138 may speak or manually submit a confirmation of completion of filling in the electronic filled form 134, or filled form 143. The information may then be stored in the filled form 143, as discussed above.

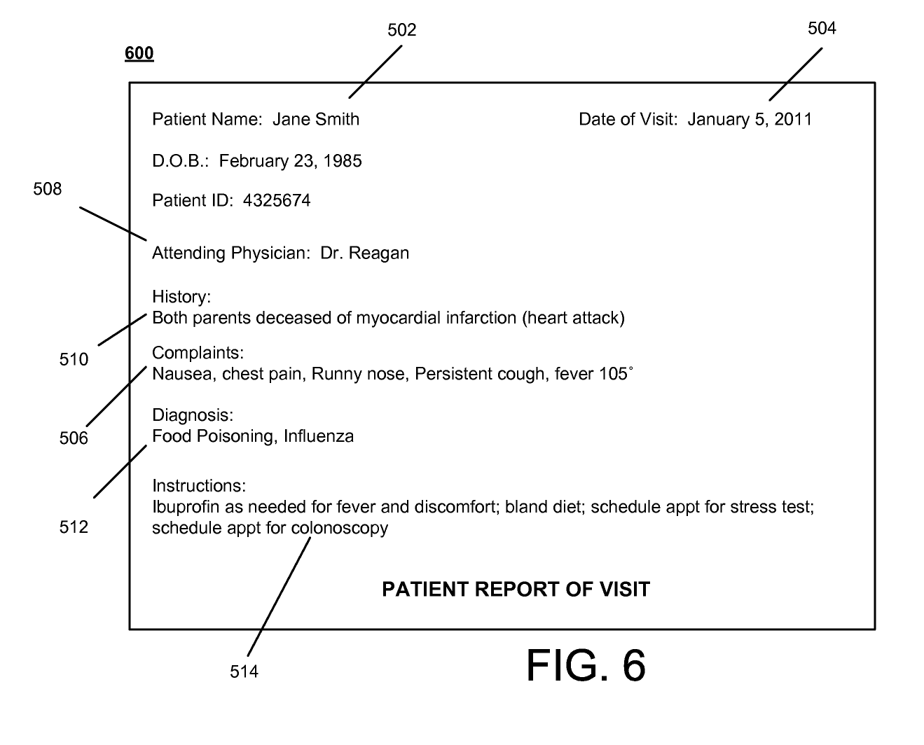

FIG. 6 depicts an example graphical view of a populated medical report. As shown in FIG. 6, a patient report of visit form 600 may be obtained based on the filled form 143 discussed above with regard to FIGS. 5a-5c. As shown in FIG. 6, the instructions field 514 may be displayed or printed in clear text format for later review by the patient or a caretaker of the patient, as well as for review and signature by the user 138 (e.g., before the form 600 is provided to the patient).

Patient privacy and patient confidentiality have been ongoing considerations in medical environments for many years. Thus, medical facility personnel may provide permission forms for patient review and signature before the patient's information is entered into an electronic medical information system, to ensure that a patient is informed of potential risks of electronically stored personal/private information such as a medical history or other personal identifying information. Further, authentication techniques may be included in order for medical facility personnel to enter or otherwise access patient information in the system 100. For example, a user identifier and password may be requested for any type of access to patient information. As another example, an authorized fingerprint or audio identification (e.g., via voice recognition) may be requested for the access. Additionally, access to networked elements of the system may be provided via secured connections (or hardwired connections), and firewalls may be provided to minimize risk of potential hacking into the system.

Further, medical facility personnel may provide permission forms for medical facility employees for review and signature before the employees' information is entered into an electronic medical information system, to ensure that employees are informed of potential risks of electronically stored personal/private information such as a medical history or other personal identifying information.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine usable or machine readable storage device (e.g., a magnetic or digital medium such as a Universal Serial Bus (USB) storage device, a tape, hard disk drive, compact disk, digital video disk (DVD), etc.) or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand alone program or as a module, component, subroutine, or other unit suitable for use in a computing environment. A computer program that might implement the techniques discussed above may be deployed to be executed on one computer or on multiple computers at one site or distributed across multiple sites and interconnected by a communication network.

Method steps may be performed by one or more programmable processors executing a computer program to perform functions by operating on input data and generating output. The one or more programmable processors may execute instructions in parallel, and/or may be arranged in a distributed configuration for distributed processing. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back end component, e.g., as a data server, or that includes a middleware component, e.g., an application server, or that includes a front end component, e.g., a client computer having a graphical user interface or a Web browser through which a user can interact with an implementation, or any combination of such back end, middleware, or front end components. Components may be interconnected by any form or medium of digital data communication, e.g., a communication network. Examples of communication networks include a local area network (LAN) and a wide area network (WAN), e.g., the Internet.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system comprising:
a medical forms speech engine that includes:
a medical speech corpus interface engine configured to access a medical speech repository that includes information associated with a corpus of medical terms;
a speech accent interface engine configured to access a speech accent repository that includes information associated with database objects indicating speech accent attributes associated with one or more speakers;
an audio data receiving engine configured to receive event audio data that is based on verbal utterances associated with a medical event associated with a patient;
a recognition engine configured to obtain a list of a plurality of candidate text strings that match interpretations of the received event audio data, based on information received from the medical speech corpus interface engine, information received from the speech accent interface engine, and a matching function;
a selection engine configured to obtain a selection of at least one of the candidate text strings included in the list; and
a form population engine configured to initiate, via a forms device processor, population of at least one field of an electronic medical form, based on the obtained selection.

2. The system of claim 1, wherein the medical event includes at least one of:
a medical treatment event associated with the patient, a medical review event associated with the patient, a medical billing event associated with the patient, a medical prescription event associated with the patient, and a medical examination event associated with the patient.

3. The system of claim 1, wherein the matching function includes at least one of:
a matching function configured to determine a first candidate text string and at least one fuzzy derivative candidate text string,
a matching function configured to determine the plurality of candidate text strings based on at least one phoneme,
a matching function configured to determine the plurality of candidate text strings based on a history of selected text strings associated with a user, and
a matching function configured to determine the plurality of candidate text strings based on a history of selected text strings associated with the patient.

4. The system of claim 1, further comprising:
a medical form interface engine configured to access a medical form repository that includes template information associated with a plurality of medical forms stored in an electronic format,
wherein the form population engine is configured to initiate population of at least one field of the electronic medical form, based on the obtained selection, and based on template information received from the medical form interface engine.

5. The system of claim 4 further comprising:
a medical context determination engine configured to determine a medical context based on the received event audio data,
wherein the medical form interface engine is configured to request template information associated with at least one medical form associated with the determined medical context from the medical form repository.

6. A computer program product tangibly embodied on a computer-readable medium and including executable code that, when executed, is configured to cause at least one data processing apparatus to:
receive event audio data that is based on verbal utterances associated with a medical event associated with a patient;
obtain a list of a plurality of candidate text strings that match interpretations of the event audio data, based on information included in a medical speech repository, information included in a speech accent repository, and a matching function;
obtain a selection of at least one of the candidate text strings included in the list; and
initiate population, via a forms device processor, of at least one field of an electronic medical form, based on the obtained selection.

7. The computer program product of claim 6, wherein the executable code, when executed, is configured to cause the at least one data processing apparatus to:
receive a confirmation of a completion of population of the electronic medical form from a user of the electronic medical form.

8. The computer program product of claim 6, wherein the executable code, when executed, is configured to cause the at least one data processing apparatus to:
obtain an identification of a user of the electronic medical form; and
obtain the list based on information included in the medical speech repository, information that is associated with the user and is included in the speech accent repository, and the matching function.

9. The computer program product of claim 8, wherein the executable code, when executed, is configured to cause the at least one data processing apparatus to:
obtain the identification of the user of the electronic medical form, based on at least one of:
receiving an indication of the identification from the user, and
obtaining the identification based on matching a portion of the event audio data with a portion of the information included in the speech accent repository, based on voice recognition.

10. The computer program product of claim 6, wherein:
the medical event includes at least one of a medical treatment event associated with the patient, a medical review event associated with the patient, a medical billing event associated with the patient, a medical prescription event associated with the patient, and a medical examination event associated with the patient; and
the verbal utterances are associated with a physician designated as a physician responsible for treatment of the patient.

11. The computer program product of claim 6, wherein the executable code, when executed, is configured to cause the at least one data processing apparatus to:
obtain an identification of the electronic medical form from a user; and
initiate transmission of template information associated with the electronic medical form to a display device associated with the user, based on the identification of the electronic medical form.

12. The computer program product of claim 6, wherein the executable code, when executed, is configured to cause the at least one data processing apparatus to:
obtain an identification of the electronic medical form, based on the received event audio data; and
initiate access to the electronic medical form, based on the identification of the electronic medical form.

13. The computer program product of claim 12, wherein the executable code, when executed, is configured to cause the at least one data processing apparatus to:
obtain the identification of the electronic medical form, based on the received event audio data, based on an association of the electronic medical form with at least one interpretation of at least one portion of the received event audio data.

14. The computer program product of claim 6, wherein the executable code, when executed, is configured to cause the at least one data processing apparatus to:
obtain the list based on obtaining the list of the plurality of candidate text strings that match interpretations of the event audio data, based on information included in the medical speech repository that includes information associated with a vocabulary that is associated with medical professional terminology and a vocabulary that is associated with a predetermined medical environment.

15. The computer program product of claim 6, wherein the executable code, when executed, is configured to cause the at least one data processing apparatus to:
receive at least one revision to the selected text string, based on input from a user.

16. The computer program product of claim 6, wherein the executable code, when executed, is configured to cause the at least one data processing apparatus to:
receive training audio data that is based on verbal training utterances associated with a user of the electronic medical form; and
initiate an update event associated with the speech accent repository based on the received training audio data.

17. The computer program product of claim 6, wherein the executable code, when executed, is configured to cause the at least one data processing apparatus to:
initiate an update event associated with the speech accent repository based on the obtained selection.

18. A computer program product tangibly embodied on a computer-readable medium and including executable code that, when executed, is configured to cause at least one data processing apparatus to:
receive an indication of a receipt of event audio data from a user that is based on verbal utterances associated with a medical event associated with a patient;
receive an indication of a list of a plurality of candidate text strings that match interpretations of the event audio data, based on information included in a medical speech repository, information included in a speech accent repository, and a matching function;
initiate communication of the list to the user;
receive a selection of at least one of the candidate text strings included in the list from the user;
receive template information associated with an electronic medical form; and
initiate a graphical output depicting a population of at least one field of the electronic medical form, based on the obtained selection and the received template information.

19. The computer program product of claim 18, wherein the executable code, when executed, is configured to cause the at least one data processing apparatus to:
initiate the graphical output depicting the population of at least one field of the electronic medical form, based on at least one of:
initiating a graphical display of the populated electronic medical form on a display device, based on the obtained selection and the received template information,
initiating a graphical output to a printer, based on the obtained selection and the received template information, and
initiating a graphical output to an electronic file, based on the obtained selection and the received template information.

20. The computer program product of claim 18, wherein the executable code, when executed, is configured to cause the at least one data processing apparatus to:
request an identification associated with the user;
receive an indication that a population of the electronic medical form is complete; and
initiate a request for a verification of an accuracy of the completed population of the electronic medical form from the user.
